(19) United States
(12) Patent Application Publication
(10) Pub. No.: US 2009/0033493 A1
(43) Pub. Date: Feb. 5, 2009

(54) Method, System and Apparatus for Writing Common Information to a Plurality of Radio Frequency Identification (RFID) Tags

(75) Inventors: Lang Lin, Potomac, MD (US); Victor Hugo Molina, Germantown, MD (US); Jens Arnold, Perry Hall, MD (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 11/831,167

(22) Filed: Jul. 31, 2007

(51) Int. Cl. G08B 13/14

(52) U.S. Cl. 340/572.1

(57) ABSTRACT

RFID methods, systems and apparatus for writing common data (RFID information) to a plurality of RFID tags, include transmitting a common-write data signal including the common data to a plurality of RFID tags located in a broadcast field, where the plurality of RFID tags receive and respectively write the common data in internal memory of the plurality of RFID tags in accordance with a common algorithm. A common-write data signal may include common identifier data. Each of a plurality of RFID tags may generate common identifier data by controlling a random number generator of the tag. Each of a plurality of RFID tags may be pre-configured (initialized) for receiving common data and writing the common data to memory in accordance with a common algorithm. Each of a reader and a plurality of RFID tags may include common algorithm for transmitting/receiving and executing a common-write-enable command that enables a common write capability of a tag (e.g., initializes a tag for receiving a common-write data signal), and for transmitting/receiving a common-write-disable command that disables common-write capability of a tag.

### BACKGROUND OF THE INVENTION

1. Field of the Invention

The present invention relates generally to radio frequency identification (RFID) methods, systems and tags, and more particularly to methods, systems and apparatus for writing common information to a plurality of RFID tags.

2. Background

Radio frequency identification (RFID) systems generally include at least one interrogator (reader) that communicates with at least one RFID tag using radio frequency (RF) signals. Each tag stores RFID tag information that may include common information and unique identification (ID) information. Each tag may be associated with a single item or unit of items (e.g., a skid, box, cargo container, truck, or the like), where the RFID tag information provides information about the item or unit of items. A tag may be associated with a person. A reader may interrogate one or a plurality of RFID tags to determine the RFID tag information stored in memory in each tag, or to write information to a tag. In this manner, it is possible to non-invasively perform various monitor and control functions, such as identifying, detecting, sorting and tracking an item associated with an RFID tag, monitoring inventory, preventing sale of out-of-date stock, preventing unauthorized entry, exit or removal from a warehouse, store or other designated location, and the like.

RFID tag information for a plurality of items may include common or redundant information. Mass produced commodity items such as drugs, vitamins, candy, food stuffs, and the like, may be manufactured in bulk or in large batches and then distributed in a plurality of small packages, such as bottles, boxes, vials, or the like, where each item and each package may be the same or substantially similar. The packaging may include the name of the manufacturer, the name of the item, certain descriptive information, advertising, warranties, coupons and the like that is the same or similar for each package. The packaging may be the same or substantially similar for items from different batches. Likewise, RFID tag information for each of these items may be substantially similar; for example, RFID tag information for packages of items from many batches over a period of years may differ only with respect to a few types of information, such as the batch number, the date of manufacture, and/or a unique identification (ID) for each item/package. RFID tags that identify same or substantially similar items may be referred to as item level tags.

Known methods and systems for writing RFID tag information to item level tags are time consuming. Known RFID tag writing techniques require a staged, one-on-one, interactive communication protocol between an interrogator and each RFID tag to write RFID tag information to the RFID tag. The staged writing process may include serially writing a plurality of segments of data each having a predetermined number of bits, e.g., words of 16 bits of data. This staged writing protocol must be repeated for each tag of a plurality of tags, even where the tags have substantially the same overall RFID information. The time required to write such item-level data to each of a plurality of tags may vary depending on a number of factors, including the amount of data and the size and structure of the tag memory. Typically, the time required may be tens of seconds or minutes in the case of writing item-level data to a few hundred tags.

### SUMMARY

The present invention includes novel methods, systems and apparatus for writing common information to a plurality of RFID tags using a single write sequence.

In one aspect, embodiments may include a method of transmitting a common-write data signal including common data to a plurality of RFID tags located in a common broadcast field, the plurality of RFID tags receiving and respectively writing the common data in internal memory of the plurality of RFID tags in accordance with a common algorithm. In embodiments, a common-write data signal may include a predetermined number of bits of data in a predetermined format, a command or a command sequence, where the common-write data signal includes common data to be recorded in each of a plurality of RFID tags. In embodiments, a common-write data signal may include common identifier data. In embodiments, common identifier data may be generated by each of a plurality of tags in accordance with a common-write algorithm common to the plurality of RFID tags. In embodiments, common-identifier data may be generated by a plurality of tags in response to a common interrogation/transmission from a reader. In embodiments, methods may include transmitting a common-write-enable command that configures/enables each of a plurality of RFID tags to receive and respectively record common data transmitted in a common transmission; in embodiments, methods may include transmitting a common-write disable command that disables a common-write capability of the plurality of tags. In embodiments, methods may include authenticating a reader to confirm that the reader is authorized to transmit common-write data to a plurality of tags. In embodiments, methods may include authenticating a plurality of tags to confirm that each tag is authorized to receive common-write data.

In another aspect, embodiments may include an RFID tag configured to receive a common-write data signal including common data, and to write the common data in internal memory of the tag in accordance with a common algorithm (common to a plurality of tags). In embodiments, a common-write data signal may include a predetermined number of bits of data in a predetermined format, a command or a command sequence, where the common-write data signal includes common data to be recorded in each of a plurality of RFID tags. In embodiments, a common-write data signal may include common identifier data. In embodiments, each of a plurality of tags may generate common identifier data. In embodiments, each of a plurality of tags may include a random number generator configured to generate common identifier data in accordance with a common algorithm. In embodiments, each of a plurality of tags may transmit common identifier data to a reader in a common-write operation. In embodiments, each of a plurality of tags may be configured (initialized) to receive and write common data to memory as part of a tag manufacturing/fabrication process; in this manner, transmission of a common-write data signal including common data to the tags may be made during or (e.g., immediately) following a tag manufacturing process. In embodiments each of a plurality of RFID tags may be configured to receive and execute a common-write-enable command that enables a common-write capability of the tag; each tag further may be configured to receive and execute a common-write-disable command that disables a common-write capability of the tag. In embodiments, a common algorithm may be implemented in hardware, software, processor executable program steps stored in internal memory of a plurality of RFID tags, or any combination thereof.

In another aspect, embodiments may include a reader configured to transmit a common-write data signal including common data to be recorded in memory by each of a plurality of RFID tags located in a broadcast field of the reader in accordance with a common algorithm. In embodiments, a common-write data signal may include a predetermined number of bits of data in a predetermined format, a command or a command sequence) including common data to be recorded in memory by each of a plurality of RFID tags located in a broadcast field of the reader. In embodiments, a common-write data signal may include common identifier data. In embodiments, a reader may be configured to transmit a common-write-enable command to be executed by at least one RFID tag located in a broadcast field of the reader to enable a common-write capability of the tag (e.g., a common-write enable command may configure each tag to receive a common-write data signal including common data to be recorded by the plurality of tags); likewise, in embodiments a reader may be configured to transmit a common-write-disable command that disables a common-write capability of a tag. In embodiments, a common-write algorithm may be implemented in hardware, software, processor executable program steps stored in internal memory of the reader, or any combination thereof.

In another aspect, embodiments may include a system including a reader that transmits a common-write data signal including common data, and a plurality of RFID tags located in a common broadcast field of the reader, where the plurality of RFID tags receive and respectively write the common data in internal memory of the plurality of RFID tags in accordance with a common algorithm.

### BRIEF DESCRIPTION OF THE DRAWINGS/FIGURES

The accompanying drawings, which are incorporated herein and form a part of the specification, illustrate exemplary embodiments of the present invention and, together with the written description, further serve to explain the principles of the invention and to enable a person skilled in the art to make and use the invention.

FIG. 1 schematically illustrates an exemplary RFID system.

FIG. 2 schematically illustrates a block diagram of an exemplary RFID reader.

FIG. 3 schematically illustrates a plan view of an exemplary RFID tag.

FIG. 4 schematically illustrates a logical memory map of an exemplary RFID tag memory.

FIG. 5 illustrates a timing sequence of an exemplary Gen-2 compliant write operation.

FIG. 6 illustrates a timing sequence of an exemplary Gen-2 compliant broadcast-write operation of the present invention.

Exemplary embodiments of the present invention will be described with reference to the accompanying drawings, wherein like numbers designate like or similar elements or features, and like numbers having different lower case letters represent corresponding elements/features. The drawing in which an element first appears typically is indicated by the leftmost digit in the corresponding reference number.

### DETAILED DESCRIPTION OF EMBODIMENTS

### Introduction

The present specification discloses one or more embodiments that incorporate features of the claimed invention. The disclosed embodiment(s) merely exemplify the claimed invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System Embodiment

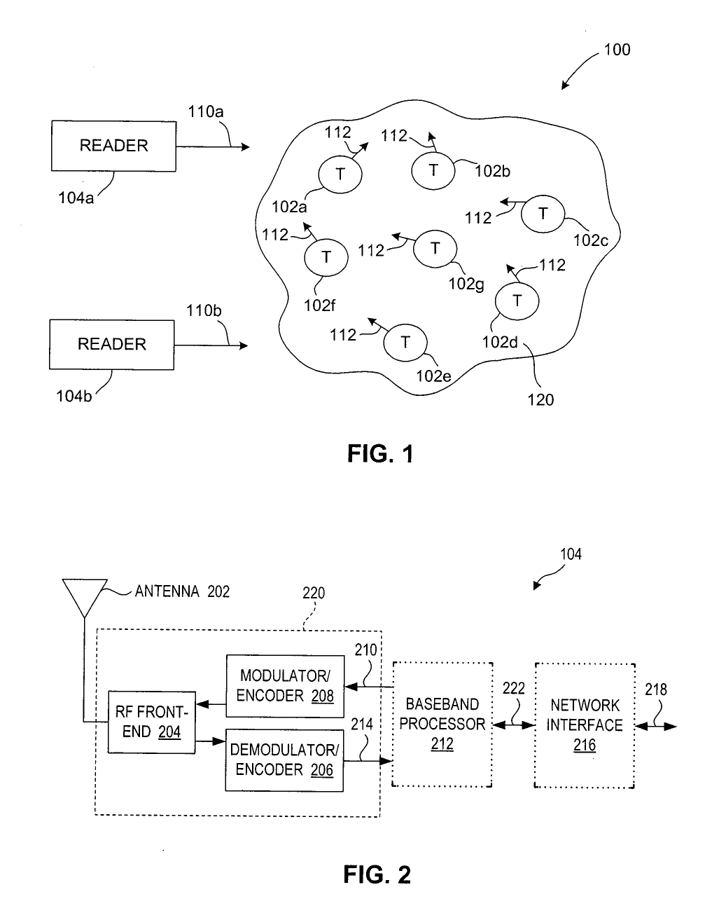

Before describing embodiments of the present invention in detail, it is helpful to describe an example RFID communications environment in which the invention may be implemented. FIG. 1 illustrates an environment 100 where a RFID tag reader 104 communicates with an exemplary population 120 of RFID tags 102. As shown in FIG. 1, the population 120 of tags includes seven tags 102a-102g. A population 120 may include any number of tags 102.

Environment 100 includes one or more readers 104 (readers 104a and 104b are shown). A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, reader 104 transmits an interrogation signal 110 having a carrier frequency to the population of tags 120. Reader 104 operates in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104 receive and obtain data from response signals 112, including but not limited to an identification number of the responding tag 102. In the embodiments described herein, a reader may be capable of communicating with tags 102 according to any suitable communication protocol, including binary traversal protocols, slotted aloha protocols, Class 0, Class 1, EPC Gen 2, any others mentioned elsewhere herein, and future communication protocols.

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions. Reader 104 may broadcast (transmit) an RF signal to a broadcast field of the reader 104. A broadcast field (coverage or coverage pattern) of a reader 104 may vary in shape and/or size; generally, a broadcast field is determined by the transmit power of a transceiver 220 and gain pattern of a antenna 202. Also coverage of different antennas 202 may overlap. Those skilled in the art readily will be able to select appropriate transceiver(s) 220 and antenna(s) 202 to provide a suitable broadcast field (coverage or coverage pattern) for a desired application.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation or write request by reader 104. For example, an interrogation or write request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation or write operation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation or write request 210, and is coupled to an input of RF front-end 204. Modulator/encoder 208 encodes interrogation or write request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

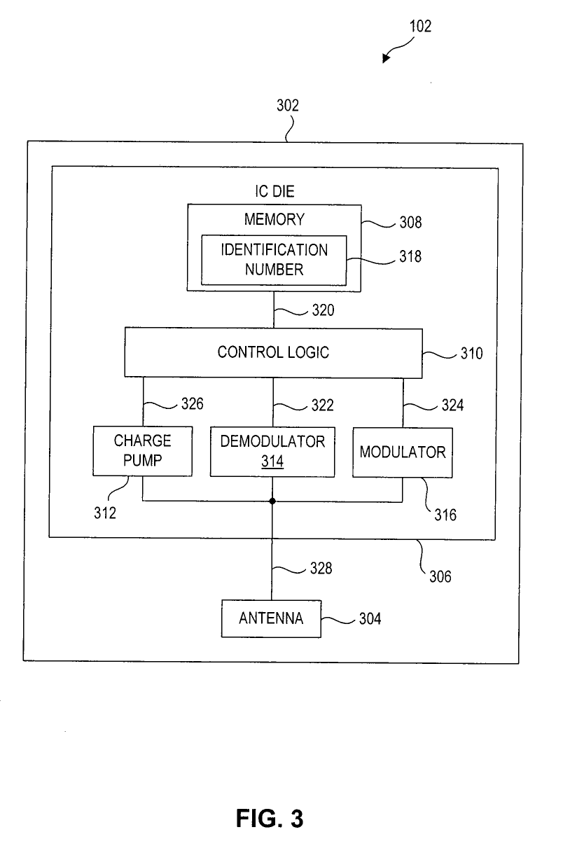

The present invention is applicable to any type of RFID tag. FIG. 3 shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, a modulator 316, and a random number generator 317. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but alternatively may be a volatile memory, such as a DRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Modulator 316 and demodulator 314 may be referred to collectively as a “transceiver” of tag 102.

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 320.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag are also applicable to embodiments of the present invention.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. Another example form of a “tag” is a tag inlay that has been attached to another surface, or between surfaces, such as paper, cardboard, etc., for attachment to an object to be tracked, such as an article of clothing, etc.

Example embodiments of the present invention are described in further detail below. Such embodiments may be implemented in the environments, readers, and tags described above, and/or in alternative environments and alternative RFID devices.

### Exemplary Embodiments

In exemplary embodiments, RFID tag writing methods of the present invention generally comprise transmitting common data to a plurality of RFID tags, where the plurality of RFID tags receive and respectively write the common data in internal memory of the plurality of RFID tags. In this manner, it will be appreciated that methods of the present invention may significantly reduce time and redundancies associated with individually writing common RFID information into a plurality of RFID tags, one at a time.

In embodiments, common-write methods of the present invention may be implemented at various stages of a tag's life. For example, in embodiments, common-write methods may be implemented as part of an initialization process during manufacture/fabrication of a plurality of related RFID tags, e.g., tags designated as item level tags. Alternatively, in embodiments common-write methods may be implemented by an RFID system customer/user to write common data to a plurality of tags in association with manufacture or inventory of a plurality of items/products associated with the plurality of tags.

In exemplary embodiments, common-write methods may include transmitting common data in various forms/formats. In an embodiment, a common-write method may include transmitting a common-write data signal including common data to be written to memory of a plurality of tags; in embodiments, a common-write data signal may include a predetermined number of bits of data provided in a predetermined format, the predetermined number of bits of data including the common data; in embodiments, a common-write data signal may include a common-write command including common data to be written to memory of a plurality of tags; in embodiments, a common-write data signal may include a command sequence, where the command sequence includes common data to be written to memory of a plurality of tags. In embodiments, the common data may include a plurality of words of data, each word including a predetermined number of bits, e.g., 16 bits of data for each word. Each word, or designated portion of a word, may correspond to respective predetermined information, such as a manufacturer's name, a date of manufacture, a batch number, a name of the item (e.g., the name of a drug), that is common to the plurality of RFID tags. In embodiments, a common-write method may include transmitting the common data at a predetermined frequency. To maintain security in the common data, in embodiments a common-write method optionally may include encrypting the common data prior to transmitting the common data to the plurality of RFID tags. In embodiments, a common-write method may use common identifier data generated by random number generator(s) of the plurality of tags to encrypt the common data. Those skilled in the art readily will appreciate alternative formats for providing and transmitting common data in accordance with a desired application.

In exemplary embodiments, a plurality of RFID tags containing common data written by a common-write method may be checked to confirm accurate writing of the common data in the respective tags. In embodiments, the plurality of RFID tags may be read to identify any defective RFID tag(s); in this regard, a defective tag may be a tag that has incorrect, incomplete or no data written in its internal memory after a common-write operation. Reading of a plurality of RFID tags may be performed by any known or later developed structure or means; reading of a plurality of RFID tags may be performed by any known or later developed protocol. Each RFID tag may be individually read by an interrogator; alternatively, a plurality of RFID tags may be interrogated by a single interrogation operation of a single interrogator. Interrogation may be performed using a standard protocol, e.g., Gen-2 access/read protocol; alternatively, interrogation may be performed using a proprietary protocol. Those skilled in the art readily will be able to select and implement interrogation methods, systems and protocol suitable for identifying a defective RFID tag in a desired application.

In exemplary embodiments, a defective RFID tag may be corrected. Generally, a defective RFID tag may be corrected by re-writing the data (e.g., common data/RFID information) in the internal memory of the tag. In an embodiment, each RFID tag may be corrected individually using a predetermined protocol. For example, the data (or a portion of the data that is incorrect) may be re-written into the internal memory of the RFID tag by a subsequent write operation. For each individual RFID tag, such write operation may be performed using any known or later developed standard protocol, e.g., Gen-2 access/write protocol. Alternatively, such write operation may be performed using any known or later developed proprietary protocol. A proprietary protocol may be an individual tag write operation or a plural tag common-write operation.

In exemplary embodiments for correcting a defective RFID tag, each defective RFID tag may use an algorithm for writing (re-writing correctly) the predetermined data into internal memory of the RFID tag. The algorithm may be implemented in hardware, software, processor executable program steps stored in internal memory, or any combination thereof. Those skilled in the art readily will be able to select and implement suitable structure, means, algorithm and protocol for correcting a defective RFID tag.

In exemplary embodiments, a common-write capability of a plurality of tags may be disabled. For example, in a case where common data is written to a plurality of RFID tags during initial manufacture of the tags, disabling of common-write capability may be self-executing by termination of the common-write initialization operation. That is, the tag may include and execute internal algorithm for executing an initialization common-write operation, but the algorithm may not support or execute a subsequent common-write operation. Alternatively, in embodiments a tag's internal algorithm and common-write protocol may terminate by execution of a common-write-disable command that causes each tag to disable common-write capability.

In embodiments, RFID tags may selectively operate in common-write mode. For example, in embodiments RFID tags may include internal algorithm that selectively operates in common-write mode in response to receipt of a common-write-enable command and common-write-disable command. Transmission of a common-write-enable command and/or common-write-disable command may be performed individually (one-on-one transmission from a reader to each RFID tag) or simultaneously (common transmission from a single reader to a plurality of RFID tags located in a broadcast field of the reader). Alternatively, in embodiments RFID tags may implement a switch for selectively enabling and disabling a common-write mode. In embodiments, a manual or electronic switch may be implemented in each tag for selectively operating the tag in a common-write enabled mode. Those skilled in the art readily will appreciate alternative methods and systems for implementing and selectively enabling a common-write enabled operation mode.

In embodiments, a common-write method may include authentication of system components. In embodiments, prior to transmission of common data to a plurality of RFID tags, methods of the present invention may include authenticating an interrogator. For example, in embodiments a method may include authenticating an interrogator to confirm that the interrogator is authorized to write or common-write information to a desired (target) plurality of RFID tags. Likewise, in embodiments, prior to transmitting common data to a plurality of RFID tags, methods of the present invention may include authenticating the plurality of RFID tags. For example, in embodiments a method may include authenticating each of a plurality of RFID tags to confirm that each tag is a desired (target) tag for receiving the common data. In embodiments, methods of the present invention may include authenticating both the interrogator and the plurality of RFID tags. Means for authenticating a reader or tags may be implemented in hardware, firmware, software, or any combination thereof in the respective reader and tags.

In exemplary embodiments, systems of the present invention may include interrogator(s) and tags configured to implement and execute one or more of the above-described methods of the present invention. In exemplary embodiments, each of a plurality of RFID tags may include an antenna and a chip (including internal memory) configured to execute a common algorithm (that is, common for at least the plurality of RFID tags), where the algorithm includes receiving common data from a common RF broadcast signal and respectively writing the common data in the internal memory of the tag. In embodiments, communication protocols, including signal frequencies, formats, sequences and timings, may be selected that are suitable for a desired system of interrogators and tags. Those skilled in the art readily will appreciate alternative interrogator and tag configurations and communication protocols for implementing embodiments of the described methods of the present invention.

### Exemplary Embodiments of Gen-2 Compliant Write Command

Exemplary embodiments are presented below for implementing methods, systems/apparatus and RFID tags of the present invention with respect to Class-1 Generation-2 UHF RFID (Gen-2) conforming/compliant RFID interrogators (readers), tags and methods. Standard specifications for RFID air interface may be found in EPCglobal EPC, EPC Radio-Frequency Identity Protocols Class-1 Generation-2 UHF RFID Protocol for Communications at 860 MHz-960 MHz Version 1.0.9 (Jan. 31, 2005), which is incorporated by reference herein in its entirety. The methods, systems and protocols discussed below are conforming/compliant with such Gen-2 standards. Those skilled in the art readily will appreciate and variously may implement alternative common-write methods of the present invention in Gen-2 standard compliant systems or other known or later developed RFID systems.

Gen-2 compliant readers and tags operate in the 860 MHz-960 MHz frequency range, and generally may implement a passive-backscatter, interrogator-talks-first (ITF) protocol. In a Gen-2 system, a reader may transmit information to a tag by modulating an RF signal. A Gen-2 system tag may receive both information and energy from an RF signal. A Gen-2 system tag may respond to a reader by modulating a reflection coefficient of its antenna, thereby generating by backscatter an information signal to the reader. Gen-2 system readers and tags may communicate in half-duplex mode, where a reader talks and tags listen, or vice-versa.

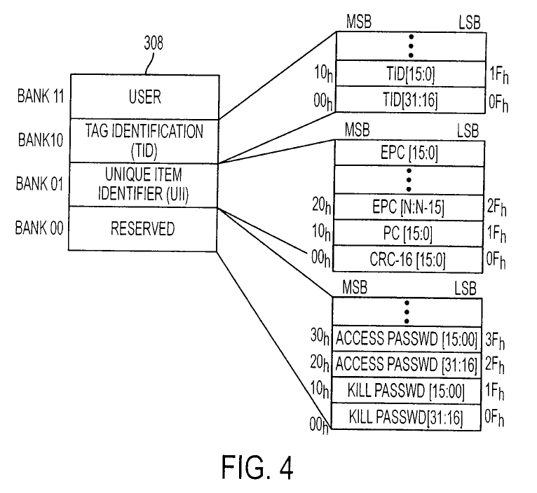

FIG. 4 schematically illustrates a logical memory map for a Gen-2 compliant RFID tag. As shown therein, a tag memory 308 may be logically separated into four distinct banks, each of which may comprise zero or more memory words: a Reserved memory bank, logically designated address ‘00’; a Unique Item Identifier (UI) memory bank, logically designated address ‘01’; a Tag Identification (TID) memory bank, logically designated address ‘10’; and a User memory bank, logically designated address ‘11’. As shown, in embodiments each of these memory banks stores RFID data in 16-bit (single word) segments, with the most significant bit (MSB) first and the least significant bit (LSB) last. The Reserved memory bank 00 contains kill and access passwords. The Unique Item Identifier (UII) memory bank 01 contains Circular Redundancy Check (CRC), Protocol Control (PC) bits, and an item identifier code (e.g., Electronic Product Code EPC) that identifies the object (item) to which the tag is or will be attached. Typically, each of the PC data and the CRC 16 data is a 16-bit word; the EPC generally is a multiple of 16-bit words, typically 64 or 96 total bits in length. The TID memory bank 10 contains an 8-bit ISO-IEC 15963 allocation class identifier and sufficient identification information for a reader to uniquely identify the custom commands and/or optional features that the tag supports. The User memory bank 11 may contain user-specific data arranged at the user's discretion.

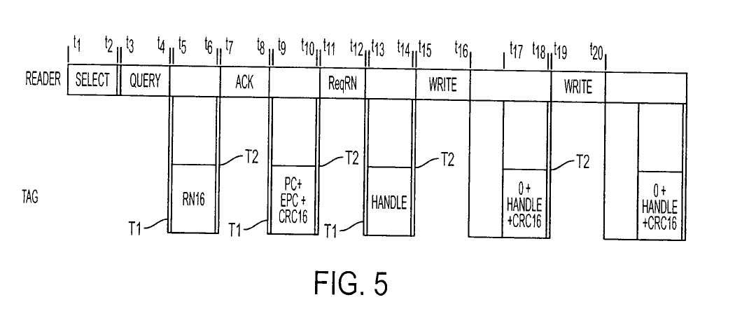

FIG. 5 schematically illustrates exemplary communication protocol for a Gen-2 standard compliant write operation. Specifically, FIG. 5 illustrates a timing sequence for interrogator (reader) and tag communications for executing a Gen-2 standard compliant write operation to write a series of 16 bit words of information in memory of a single tag. In the exemplary procedure, a reader may transmit a continuous wave (CW) radio frequency (RF) signal and modulate the signal to carry/transmit a series of predetermined commands at predetermined timing sequences; a tag may receive the CW/RF signal, absorb/extract energy from the CW/RF signal, receive, decode and execute the commands, and modulate a reflection coefficient of its antenna to transmit by backscatter signal respective predetermined responses (reply signals) to the commands. The reader may receive and process response signals transmitted by a tag or tags. Communication timing sequences may be executed in accordance with an algorithm that is be stored as respective processor executable program steps in internal memory of the reader and tag. Certain timing values, e.g., timing values T1 and T2 may be set compliant with Gen-2 standards. Those skilled in the art readily will be able to select timing sequences and values suitable to desired system applications.

As shown in FIG. 5, at time t1-t2, a reader may initiate a Gen-2 standard compliant write operation by transmitting a Select command. A target tag may receive the Select command and transition to a state for receiving a further command. After a minimum time period compliant with Gen-2 protocol, at time t3-t4 the reader may transmit a Query command. The target tag may receive the Query command and, starting within a time period T1 from the end of the Query command, at time t5-t6, the target tag may generate by backscatter a Query reply signal including a random number (RN 16) generated by random number generator RNG 317 of the tag 102 and transition to a state for receiving a further command. The reader may receive the Query reply signal including the RN 16 data and, starting within a time period T2 from the end of the Query reply signal, at time t7-t8, the reader may transmit an acknowledge command (ACK) including the RN 16 data. The target tag may receive the ACK command and, starting within a time period T1 from the end of the ACK command, at time t9-t10 the target tag may generate by backscatter an ACK reply signal including PC+EPC+CRC 16 data stored in the tag memory. The reader may receive the ACK reply signal and, starting within a time period T2 from the end of the ACK reply signal, at time t11-t12 the reader may transmit a ReqRN command, again including the RN 16 data. The target tag may receive the ReqRN command and, starting within a time period T1 from the end of the ReqRN command, at t13-t14 the target tag may generate by backscatter a ReqRN reply signal including a new random number RN 16, also known as a “handle,” generated by the tag's random generator RNG 317. The reader may receive the ReqRN reply signal and, within a time period T2 from the end of the ReqRN reply signal, at time t15-t16, the reader may transmit a Write command including the handle, memory bank designation, address designation, and at least a portion of the data to be recorded in memory of the tag, e.g., a 16-bit word. The portion of the data to be recorded optionally also may be encrypted; for example, the data may be XOR'd with unique identifier information (handle/RN 16). The target tag may receive the Write command, optionally decrypt the received data using the unique identifier information (handle/RN 16), and write the data to the designated address in memory, in accordance with the internal algorithm. Starting within a 20 ms time period from the end of the Write command (where each RFID tag variably may use the 20 ms time period, or some portion thereof, to absorb energy from the CW/RF signal, e.g., to execute the Write command and/or transmit a Write reply signal), at a time period t17-t18, the target tag also may generate by backscatter a Write reply signal including 0+handle+CRC 16 data. The reader may receive the Write reply signal, including the random number “handle” data and, starting within a time period T2 from the end of the Write reply signal, at time t19-t20 the reader may transmit a further command. In the illustrated embodiment, the reader transmits a further Write command, including another portion of data to be written to the tag memory, e.g., another 16 bit word. In this manner, as shown in FIG. 5, the Write command timing sequence and protocol may be repeated a plurality of times to transmit and record data to memory in the tag, word by word.

### Proposed Exemplary Embodiments of Common-Write Protocol

In proposed exemplary embodiments, common-write methods of the present invention may write common data into the memory of a plurality of RFID tags using a single common-write command or command sequence. In exemplary embodiments, the data may include data/RFID information that is common to each of a target plurality of RFID tags. In embodiments, the data may be transmitted in a format suitable for storage in RFID tag memory 308 illustrated above in FIG. 4.

In proposed exemplary embodiments, a reader and a plurality of RFID tags are configured with common algorithm including respective complementary processor-executable program steps for communicating in a Gen-2 compliant protocol to perform a common-write operation. In embodiments, an interrogator (reader) may be configured (e.g., programmed) to transmit common data to a plurality of RFID tags located in a broadcast field of the reader, and the plurality of tags each may be configured (e.g., programmed) to receive and respectively write the common data in internal memory of the plurality of tags in accordance with a common algorithm. In embodiments, a reader may be configured to transmit a common-write data signal including common data to a plurality of RFID tags in accordance with a predetermined timing sequence, e.g., a common-write command or a common-write command sequence. In embodiments, each of a plurality of RFID tags may be programmed to receive and/or respond to the predetermined timing sequence; e.g., each tag may selectively generate by backscatter a response/reply signal to a command transmitted to the tag, where each response may include RFID information common to all tags and/or RFID information unique for each tag.

In proposed exemplary embodiments, a plurality of RFID tags may be provided with a common algorithm that sets (or re-sets) each RFID tag in a common-write mode. In proposed exemplary embodiments, each tag may be set in the common-write mode during initial manufacture/fabrication of the tag. Alternatively, in proposed exemplary embodiments each tag may be set in common-write mode in response to receipt and execution of a common-write-enable command. Alternatively, in proposed exemplary embodiments, each tag may be set in a common-write mode by operation of an electronic or manual switch of the tag. Those skilled in the art readily will appreciate alternative methods, means and structure for setting (or re-setting) a plurality of target/related tags in a common-write configuration/mode suitable for Gen-2 compliant protocol or any other desired known or later developed protocol.

In proposed exemplary embodiments, when each tag of a related/target plurality of tags is set (or re-set) in common-write mode, the tag's random number generator RNG 317 may be initialized/set to generate a common (same) initial random number (“common RN 16”). In this manner, in embodiments each of the plurality of tags may be enabled to generate by backscatter a common initial response/reply signal, e.g., in a common-write communication sequence. Each tag of a target/related plurality of tags further may be configured (e.g., programmed) to generate in sequence additional ‘common random numbers’ (‘common RN 16’ or ‘ common handle’ data) in subsequent common response communications to a reader. In this manner, each tag of a plurality of tags may appear common (same or substantively the same) to the reader, thereby enabling simultaneous writing of common data to each of the plurality of RFID tags in a single, common-write operation. Further, as discussed above, common identifier data generated by controlling the random number generator RNG 317 of each of a plurality of tags may be used to encrypt common data transmitted to a plurality of tags.

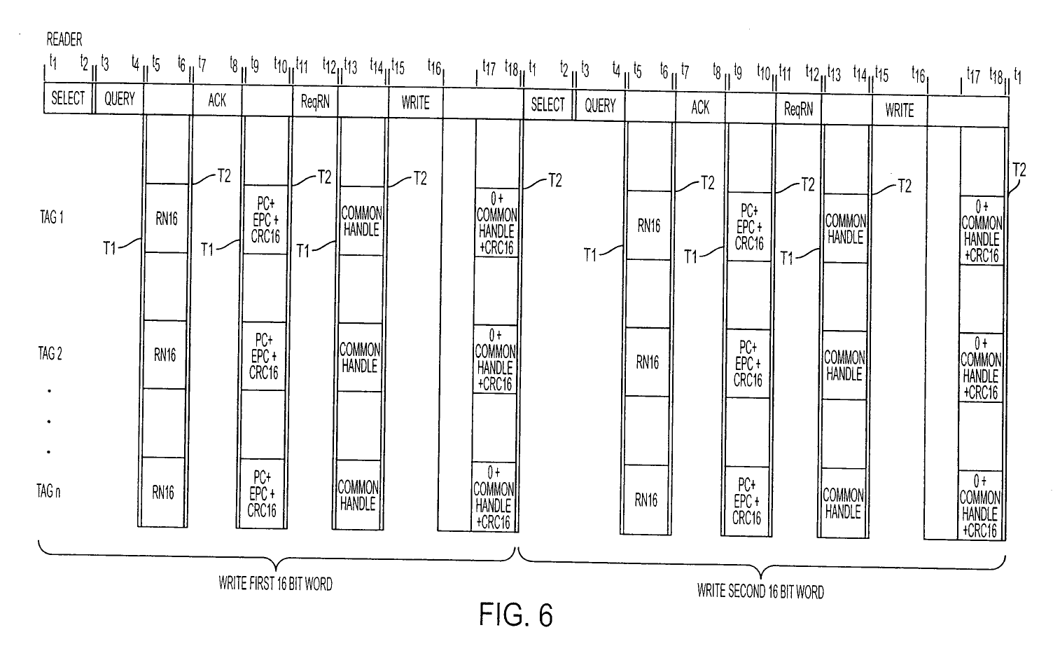

FIG. 6 schematically illustrates proposed exemplary protocol for a common-write (group-write) operation in a Gen-2 compliant RFID system. Specifically, FIG. 6 illustrates a timing sequence for interrogator (reader) and tag communications for executing a Gen-2 compliant common-write operation to write a series of 16 bit words of information in internal memory of a plurality of RFID tags (n tags) located in a broadcast field of the reader. As in the Gen-2 standard compliant write protocol of FIG. 5, in the proposed exemplary common-write protocol of FIG. 6 a reader may transmit a continuous wave (CW) radio frequency (RF) signal and modulate the signal to carry/transmit a series of predetermined commands at predetermined timing sequences; each tag may receive the CW/RF signal, absorb/extract energy from the CW/RF signal, receive, optionally decode, and execute the commands, and modulate a reflection coefficient of its antenna to transmit by backscatter signal respective responses to the commands, all in accordance with a common algorithm (common to the plurality of tags). As discussed above, in embodiments a common algorithm may be stored as processor executable program steps in internal memory of the reader and tags, respectively.

In proposed exemplary embodiments, as shown in FIG. 6, at time t1-t2, a reader may initiate a common-write operation by transmitting a Select command in its broadcast field. Each tag in the broadcast field may receive the Select command and transition to a state for receiving a further command. After a minimum time period compliant with Gen-2 protocol, at time t3-t4 the reader may transmit a Query command. Each tag may receive the Query command and, starting within a time period T1 from the end of the Query command, at time t5-t6, each tag may generate by backscatter a common Query reply signal including a common random number (“common RN 16”). The reader may receive the common Query reply signal(s) including the common RN 16 data and, starting within a time period T2 from the end of a common Query reply signal, at time t7-t8, the reader may transmit an acknowledge command (ACK) including the common RN 16 data. Each tag may receive the ACK command and, starting within a time period T1 from the end of the ACK command, at time t9-t10 each tag may generate by backscatter a common ACK reply signal including its PC+EPC+CRC 16 data. The reader may receive the common ACK reply signal(s) and, starting within a time period T2 from the end of a common ACK reply signal, at time t11-t12 the reader may transmit a ReqRN command, again including the common RN 16 data. Each tag may receive the ReqRN command and, starting within a time period T1 from the end of the ReqRN command, at t13-t14 each tag may generate by backscatter a common ReqRN reply signal(s) including a common handle (e.g., a further common RN 16 that may be the same or different from the initial common RN 16, in accordance with the common algorithm). The reader may receive a common ReqRN reply signal(s) and, within a time period T2 from the end of a common ReqRN reply signal, at time t15-t16, the reader may transmit a (common-) Write command including the common handle, memory bank designation, address designation, and at least a portion (e.g., a 16 bit word) of the common data to be written to each of the plurality of tags. The portion of the data to be written optionally also may be encrypted; for example, the data may be XOR'd with common identifier information (e.g., common handle/common RN 16). Each tag may receive the (common-) Write command, optionally decrypt the received data using the common identifier information (common handle/common RN 16), and write the common data to the designated address in its memory, in accordance with the common algorithm. Starting within a 20 ms time period of the end of the (common-) Write command (where each tag variably may use the 20 ms time period, or some portion thereof, e.g., to absorb energy sufficient to execute desired functions, such as execute a common write operation and/or transmit a common Write reply signal), at a time period t17-t18, each tag may generate by backscatter a Write reply signal including 0+common handle+CRC 16 data.

In proposed exemplary embodiments, writing of multiple words of RFID information to a plurality of RFID tags in common-write operation may be performed in a manner similar to a Gen-2 standard compliant write operation for writing multiple words of data to a single tag. That is, in embodiments, a plurality of standard compliant Write command operations may be successively performed in a common-write mode. However, since different tags of the plurality of tags may operate at different timings (that is, even though each tag may be manufactured/fabricated by the same process, different tags may absorb energy or execute functions more quickly than other tags during the 20 ms time period following the Write command, e.g., due to manufacturing tolerances), one or more of the plurality of tags may violate (or not conform to) a common Gen-2 standard compliant T2 timing sequence at termination of (common-) Write command processing. In proposed exemplary embodiments, a reader nevertheless may proceed with successive (common-) Write command(s), similar to the Gen-2 standard compliant Write command operation illustrated in FIG. 5. In this case, tags that violate (or fail to conform to) a common Gen-2 standard compliant T2 time period at the end of the Write command in the common-write environment may fail to successfully perform one or more successive common-write process(es) and therefore be ‘defective.’ Such defective tags may be detected, e.g., by standard Gen-2 compliant protocol, and corrected by performing a subsequent write or common-write operation to re-write the common data to a defective tag.

Alternatively, as illustrated in FIG. 6, in proposed exemplary embodiments a common-write protocol may be repeated in its entirety, e.g., for each 16-bit word of common data. In this manner, the timing sequence and protocol may be repeated a plurality of times to transmit and record the common data to memory in each tag, word by word, with little incidence of common-write failure due to any violation of the Gen-2 standard compliant T2 time period at the end of the (common-) Write command.

### Alternative Proposed Exemplary Embodiments of Common-Write Protocol

In alternative proposed exemplary embodiments, a reader and plurality of tags may be configured (e.g., programmed) to ignore certain differences in information/data transmitted in commands and tag responses (such as unique RFID information) during a common-write operation. For example, a reader may be configured (e.g., programmed) to count the number of digits in a reply signal without regard to the content of the reply signal. Alternatively, or in addition, in proposed exemplary embodiments, a reader may be configured (e.g., programmed) to operate in common-write mode strictly on a timing sequence basis, regardless of response signal data or timing. For example, a reader may be configured (e.g., programmed) to operate in common-write mode assuming that each tag located in a broadcast field of the reader will operate in common fashion, generating by backscatter appropriate (e.g., common) response signals at common timing sequence, and the reader may transmit a predetermined command sequence (including common data) at a predetermined timing sequence. A plurality of tags may be configured (programmed) to execute a corresponding predetermined sequence of operations at a corresponding predetermined timing. In this manner, each of a related plurality of RFID tags located in a broadcast field of the reader may receive and write common data to internal tag memory in response to transmission of a single transmission signal carrying the common data.

While various proposed embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described proposed exemplary embodiments, but should be defined only in accordance with the following claims and their equivalents.

1. A method of writing common data to a plurality of radio frequency identification (RFID) tags in a common write operation, comprising:
transmitting a common-write data signal to a plurality of RFID tags located in a broadcast field, the common-write data signal including common data to be written to each of the plurality of tags; and
respectively writing the common data in internal memory of the plurality of tags in accordance with a common algorithm.

2. The method of claim 1, said transmitting a common-write data signal comprising transmitting a predetermined number of bits of data in a predetermined format.

3. The method of claim 1, further comprising:
identifying from said plurality of tags a defective tag having incorrect data written in the internal memory of the tag by reading at least a portion of the tag memory containing common data.

4. The method of claim 3, further comprising:
correcting the defective tag by rewriting the common data in the internal memory of the defective tag.

5. The method of claim 1, further comprising:
disabling a common-write capability of the plurality of tags.

6. The method of claim 5, said disabling a common-write capability including transmitting a common-write-disable command to the plurality of tags.

7. The method of claim 1, further comprising:
authenticating a reader that transmits the common-write data signal prior to transmitting the common-write data signal to the plurality of tags.

8. The method of claim 1, further comprising:
authenticating the plurality of tags prior to transmitting the common-write data signal to the plurality of tags.

9. The method of claim 1, further comprising:
encrypting the common data prior to transmitting the common-write data signal to the plurality of tags.

10. The method of claim 9, said encrypting including encrypting the common data using random number identifier data common to the plurality of tags.

11. The method of claim 1, further comprising:
prior to transmitting the common-write data signal, transmitting a common-write-enable command to the plurality of tags; and
the plurality of tags receiving the common-write-enable command and respectively executing internal processing to enable common-write capability.

12. The method of claim 1, further comprising:
transmitting a common-write command sequence to the plurality of tags located in the broadcast field, the common-write command sequence comprising a common-write command as the common-write data signal and common data to be written to each of the plurality of tags.

13. The method of claim 12, further comprising:
transmitting a sequence of common response signals from the plurality of tags, the sequence of common response signals including respective response signals having identifier information common to each of the plurality of tags, the common identifier information being generated in accordance with the common algorithm.

14. The method of claim 13, said transmitting a common-write command sequence comprising transmitting at least one command including common identifier information determined from the respective response signals transmitted by the plurality of tags.

15. The method of claim 13, further comprising controlling a random number generator in each of the plurality of tags in accordance with the common algorithm to generate a common random number as common identifier information in each of the plurality of tags.

16. A radio frequency identification (RFID) system, comprising:
an RFID reader that transmits a common-write data signal including common data; and
a plurality of RFID tags located in a broadcast field of the reader, each tag including internal memory and configured to execute an algorithm common to the plurality of tags, the common algorithm including receiving the common-write data signal and writing the common data in the internal memory of the tag.

17. A radio frequency identification (RFID) tag, comprising:
an antenna that receives a radio frequency signal; and
a chip including internal memory and a processor configured to execute an algorithm common to a plurality of related RFID tags, the common algorithm comprising:
receiving a common-write data signal including common data to be written to the internal memory of the plurality of related RFID tags, and
writing the common data in the internal memory of the tag.

18. The RFID tag of claim 17, further comprising:
a random number generator,
the processor controlling the random number generator to generate a common random number as common identifier data to be transmitted by the tag in accordance with the common algorithm.

19. The RFID tag of claim 18, the common algorithm further comprising:
receiving and executing a common-write command comprising the common identifier data and common data to be written to the internal memory.

20. The RFID tag of claim 17, the common algorithm including receiving and executing a common-write command sequence comprising:
receiving and executing a first common command,
transmitting a common response to the first common command,
receiving and executing a second common command including common data to be written to the internal memory, and
writing the common data in the internal memory.

21. The RFID tag of claim 17, the common algorithm including receiving and executing a common-write command sequence comprising:
receiving and executing a first common command,
transmitting a common response signal including common identifier data in response to the first common command,
receiving and executing a second common command including the common identifier data and common data to be written to the internal memory, and writing the common data in the internal memory.

22. The RFID tag of claim 17, the common algorithm further including receiving and executing a common-write-enable command prior to receiving the common-write data signal, the common-write enable command enabling a common-write capability of the RFID tag.

23. The RFID tag of claim 17, the common algorithm further including receiving and executing a common-write-disable command, the common-write-disable command disabling a common-write capability of the RFID tag.

24. A radio frequency identification (RFID) reader comprising;
an antenna;
a transceiver that receives and transmits radio frequency signals via said antenna; and
a processor that controls said transceiver to transmit a common-write data signal to a broadcast field of the reader in accordance with a common-write algorithm, the common-write data signal including common data to be written to internal memory of each of a plurality of RFID tags located in the broadcast field in accordance with the common-write algorithm.

25. The RFID reader of claim 24, the common-write data signal being a predetermined number of bits of data in a predetermined format.

26. The RFID reader of claim 24, said reader being configured to transmit a common-write command including common identifier data and common data to be written to memory of the plurality of external tags located in the broadcast field of said reader in accordance with the common-write algorithm.

27. The RFID reader of claim 26, said reader determining the common identifier data from a common response signal of the plurality of external tags in accordance with the common-write algorithm.

28. The RFID reader of claim 24, the common-write algorithm including executing a common-write command sequence comprising:
transmitting a first common command to the plurality of tags,
receiving a common response signal in response to the first common command, and
transmitting a second common command to the plurality of tags, the second command including common data to be written to internal memory of the plurality of external tags.

29. The RFID reader of claim 24, the common-write algorithm including executing a common-write command sequence comprising:
transmitting a first common command to the plurality of RFID tags,
receiving a common response signal from the plurality of tags, the common response signal including common identifier information, in response to the first common command, and
transmitting a second common command to the plurality of tags, the second common command including common identifier data determined from the response signal and common data to be written to internal memory of the plurality of external tags.
